(19) United States
(12) Patent Application Publication
(10) Pub. No.: US 2024/0044341 A1
(43) Pub. Date: Feb. 8, 2024

(54) COOLER MOUNT ARRANGEMENT FOR GAS COMPRESSORS

(71) Applicant: SULLAIR, LLC, Michigan City, IN (US)

(72) Inventor: Andrew SWART, Michigan City, IN (US)

(21) Appl. No.: 18/268,570

(22) PCT Filed: Dec. 21, 2020
(86) PCT No.: PCT/US20/66432

§ 371 Date: Jun. 20, 2023

(51) Int. Cl. F04D 29/58; F04D 19/00; F28D 1/04

(52) U.S. Cl. CPC F04D 29/5826; F04D 19/002; F28D 1/0426; F28D 2021/0049

(57) ABSTRACT

Example implementations involve a gas compressor package and a cooling system for a gas compressor involving an aftercooler configured to receive heated compressed air from the gas compressor and cool the received compressed air, an oil cooler configured to receive heated oil from the gas compressor and configured to cool the received heated oil, and at least one fan unit pulling air to create an airflow through the aftercooler and the oil cooler, wherein the aftercooler is oriented at angle to a horizontal plane and angled relative to the airflow created by the at least one fan unit.

### BACKGROUND

### Field

The present disclosure generally relates to gas compressors, and more specifically, to gas compressors with cooler mounts arranged at a relative angle.

### Related Art

In the related art, air or gas compressors are used for a variety of applications to produce compressed air or compressed gas from atmospheric pressure air or atmospheric gas. In these related art systems, the air or gas to be compressed is pulled into a compression chamber through a filter and compressed along with lubricating oil, which is non-compressible. The lubricating oil purpose is essentially to keep the rotors and the internals of the compressor cool during the compression operation. As the oil absorbs heat from the rotors and internals during operation, the temperature of the oil increases. Thus, related art systems include an oil cooler to keep oil temperature regulated.

Further in the related art systems, the air or gas can also increase in temperature during the compression operation. Thus, related art systems also include an aftercooler that cools the compressed air or gas down from the temperature produced inside the compression unit to a lower temperature more suitable for the required applications. In the related art systems, both the oil cooler unit and the aftercooler function as heat radiators, dissipating heat by passing the oil or compressed air through a series of tubes and blowing air across the tubes. In the related art systems, the oil cooler and the aftercooler are oriented in the same plane parallel to each other adjacent to the exterior wall housing the compressor system and air is pulled into the system from outside using one or more fans or blowers. In these related art systems, this structure can result in the internal air of the housing being heated causing the atmospheric air or gas to be increased prior to being drawn into the compressor. This pre-heating of the atmospheric air or gas introduces additional heat into the system that must be dissipated by the aftercooler resulting in a need for larger air coolers. Example implementations of the present disclosure may address this situation and allow the usage of smaller aftercoolers by improving heat dissipation within the housing.

### SUMMARY

Aspects of the present disclosure include a gas compressor package. The gas compressor package may include a gas compressor, a motor mechanically coupled to the gas compressor and applying torque to the motor to compress gas within the gas compressor, an aftercooler communicatively coupled to the gas compressor and configured to cool compressed air that has exited the gas compressor, an oil cooler communicatively coupled to the gas compressor and configured to cool oil that has exited the gas compressor, and at least one fan unit pulling air from outside the gas compressor package to create an airflow within the gas compressor package and pushing the airflow through the aftercooler and the oil cooler, wherein the aftercooler is oriented at angle to a horizontal plane of the gas compressor package and angled relative to the airflow within the gas compressor package.

Additional aspects of the present disclosure include a gas compressor package, wherein the aftercooler and the oil cooler are located above the gas compressor and the motor.

Further aspects of the present disclosure include a gas compressor package, wherein the aftercooler is oriented at an angle of 45° to the horizontal plane of the gas compressor package.

Additional aspects of the present disclosure include a gas compressor package, wherein the at least one fan unit is positioned to pull air horizontally through a side of the gas compressor package, wherein the created airflow is a horizontal airflow within the gas compressor package.

Further aspects of the present disclosure include a gas compressor package, wherein the oil cooler is oriented parallel to the horizontal plane of the gas compressor package and parallel to airflow within the gas compressor package.

Additional aspects of the present disclosure include a gas compressor package, wherein at least one fan unit is positioned to pull air vertically downward through the gas compressor package, wherein the created airflow is a vertical airflow within the gas compressor package.

Further aspects of the present disclosure include a gas compressor package, wherein the oil cooler is oriented at an angle to the horizontal plane of the gas compressor and at an angle to the vertical airflow within the gas compressor package.

Additional aspects of the present disclosure include a gas compressor package, wherein the oil cooler and the aftercooler form a V-shape, wherein at least one fan unit is positioned in a center of the V-shape.

Further aspects of the present disclosure include a cooling system for a gas compressor. The cooling system includes an aftercooler configured to receive heated compressed air from the gas compressor and cool the received compressed air, an oil cooler configured to receive heated oil from the gas compressor and configured to cool the received heated oil, and at least one fan unit pulling air to create an airflow through the aftercooler and the oil cooler, wherein the aftercooler is oriented at angle to a horizontal plane and angled relative to the airflow created by at least one fan unit.

Additional aspects of the present disclosure include a cooling system, wherein the aftercooler is oriented at an angle of 45° to the horizontal plane.

Further aspects of the present disclosure include a cooling system, wherein at least one fan unit is positioned to pull air horizontally, wherein the created airflow is a horizontal airflow.

Additional aspects of the present disclosure include a cooling system, wherein the oil cooler is oriented parallel to the horizontal plane and parallel to airflow created by at least one fan unit.

Further aspects of the present disclosure include a cooling system, wherein at least one fan unit is positioned to pull air vertically downward, wherein the created airflow is a vertical airflow.

Additional aspects of the present disclosure include a cooling system, wherein the oil cooler is oriented at an angle to the horizontal plane and at an angle to the vertical airflow created by at least one fan unit.

Further aspects of the present disclosure include a cooling system, wherein the oil cooler and the aftercooler form a V-shape, wherein at least one fan unit is positioned in a center of the V-shape.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are used to indicate correspondence between referenced elements.

FIGS. 1 and 2 illustrate perspective views of an example air compressor package, in accordance with an example implementation of the present disclosure.

FIGS. 3-6 illustrate side views of the example air compressor package, in accordance with an example implementation of the present disclosure.

FIG. 7 illustrates a perspective view of an example air compressor package, in accordance with another example implementation of the present disclosure.

FIG. 8 illustrates a side view of the example air compressor package, in accordance with the other example implementations of the present disclosure.

FIG. 9 illustrates a top view of the example air compressor package, in accordance with the other example implementations of the present disclosure.

FIGS. 10 and 11 illustrate perspective views of an example air compressor package, in accordance with still another example implementation of the present disclosure.

### DETAILED DESCRIPTION

The following detailed description provides further details of the figures and example implementations of the present application. Though different combination features may be described in different example implementations, features are not limited to the specific combinations described and may be combined in other combinations that might be apparent to a person of ordinary skill in the art. Further, terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

Example implementations described herein involve a compressor package having an oil cooler and an aftercooler arranged at an angle relative to each other based on the amount of air flowing through the coolers and desired exit temperature. This configuration may reduce external surface of the compressor packaging taken up by the cooler surfaces. Further, this arrangement may also reduce pre-heating of air or gas supplied into the compressor by allowing waste heat to be exhausted away from the compressor inlet. This arrangement may allow for smaller cooling fans to be used and may allow the overall size of the compressor package to be reduced. Additional aspects of example implementations may be readily apparent to a person of ordinary skill based on the attached drawings and the following detailed description of example implementations of the present disclosure.

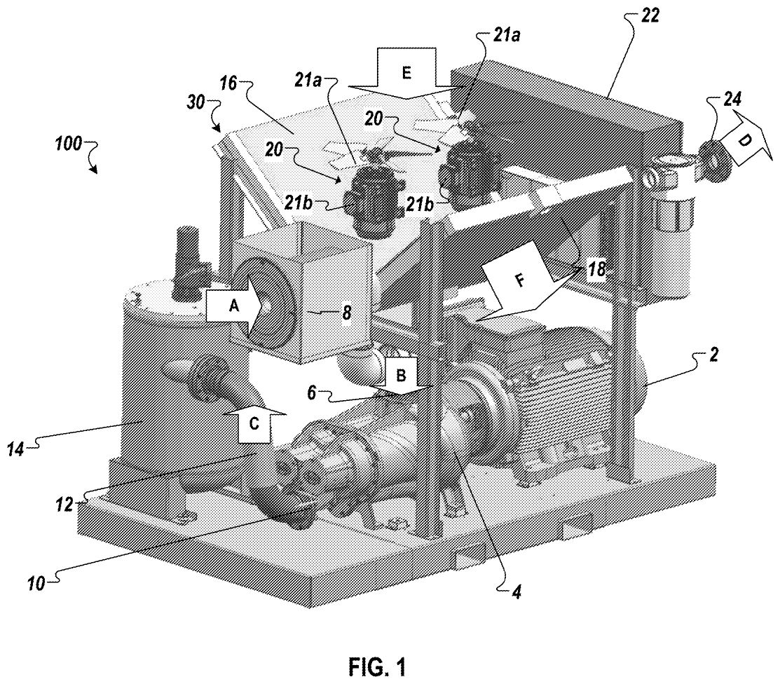

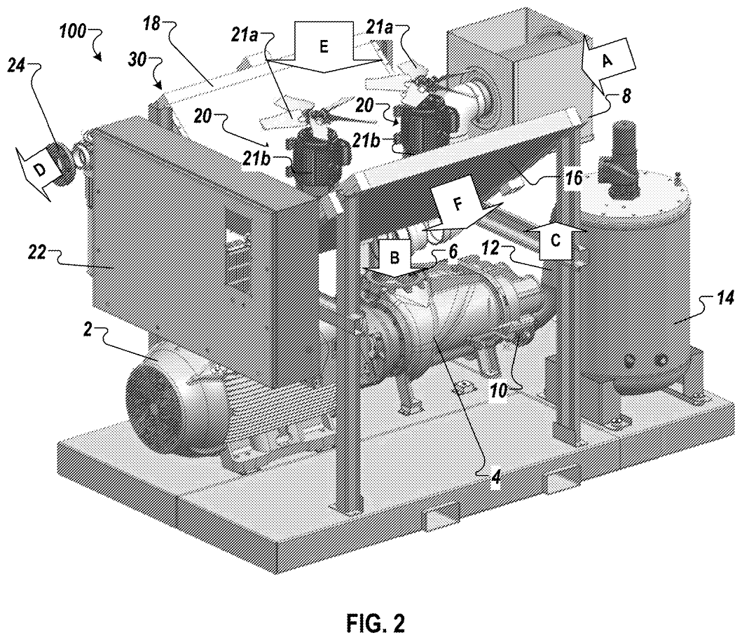

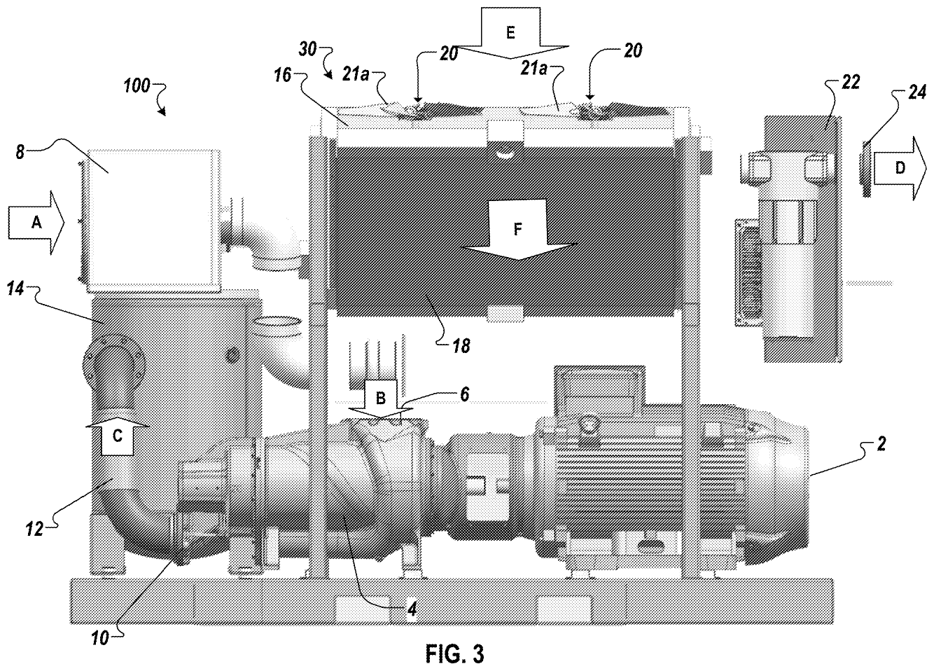

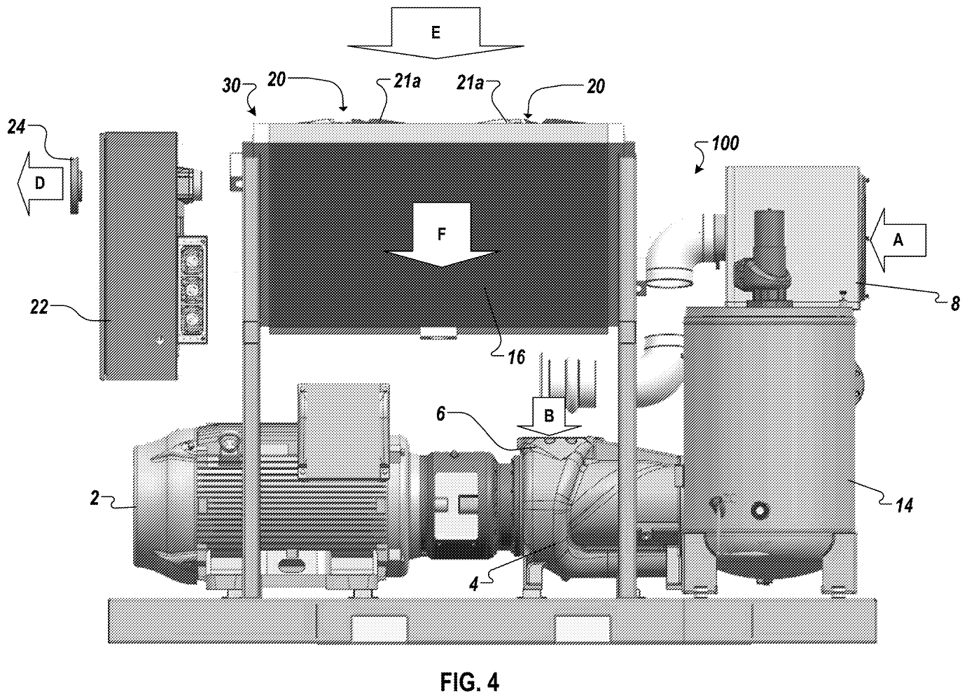

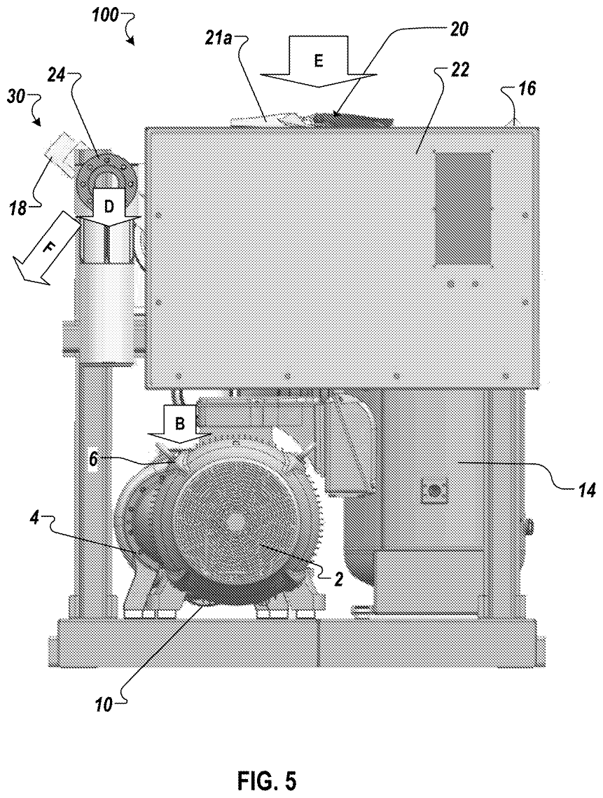

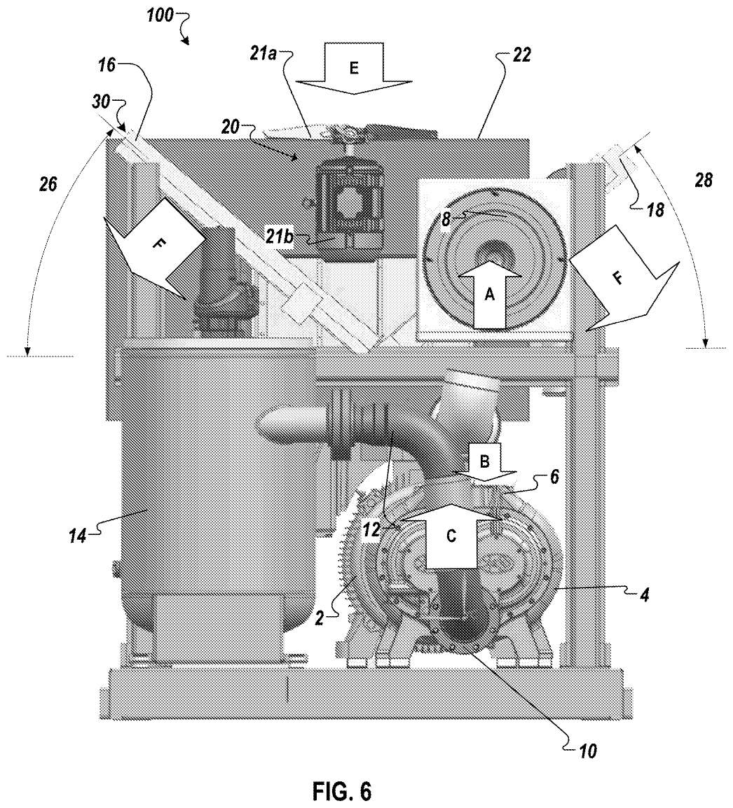

FIGS. 1 and 2 illustrate perspective views of an example air compressor package 100, in accordance with an example implementation of the present disclosure. Further, FIGS. 3-6 illustrate side views of the example air compressor package 100, in accordance with an example implementation. The compressor package 100 may be used in a variety of applications requiring a supply of compressed air. For example, the compressor package may be used to supply compressed air to drive pneumatically actuated equipment or any other application requiring compressed air or other compressed gas.

The air compressor package 100 may be enclosed by a housing (removed in FIGS. 1-6) that provides openings or slits through which air may be drawn in or exhausted from the compressor package 100. The compressor package 100 may include a gas or air compressor 4 mechanically coupled to a motor 2. In some example implementations, the gas or air compressor 4 may be a twin-screw compressor or any other type of compressor that might be apparent to a person of ordinary skill in the art. Further, the motor 2 may be an electric motor, a diesel motor, a gasoline motor, or any other motor that a person of ordinary skill in the art may use to drive a compressor.

The compressor package 100 may also include a filter unit 8 through which external air is drawn (arrow A) into the compressor package 100. The filter unit 8 may be communicatively coupled to an inlet 6 of the compressor 4 by one or more tubes or pipes. The air drawn into the compressor package 100 may travel from the filter unit 8 through the inlet 6 and into the compressor 4 (arrow B).

Within the compressor 4, the air may become compressed through operation of the compressor 4 based on torque applied by the motor 2. Within the compressor 4, the air may mix with lubricating oil that keeps the rotors and compressor internal components cool. After compression, the compressed air and hot oil mixture exits the compressor 4 through a compressor outlet 10 and travels through tubes or pipes 12 communicatively coupling the compressor 4 to a separator tank 14 (arrow C). Within the separator tank 14, the compressed air is separated from the oil through swirling motion. The separator tank 14 may be communicatively coupled to the aftercooler 18 and the oil cooler 216.

The separated compressed air is provided to the aftercooler 18 via tubes or pipes (hidden in the attached figures to allow visualization of the other components). Within the aftercooler 18, the compressed air is circulated through small tubes providing increased surface area to allow cooling of the compressed air as described in greater detail below. Once cooled, the compressed air exits the compressor package through a compressor package outlet 24 (arrow D).

Once separated from the compressed air, the hot oil is provided to the oil cooler 16 via tubes or pipes (hidden in the attached figures to allow visualization of the other components). Within the oil cooler 16, the hot oil is circulated through small tubes providing increased surface area to allow cooling of the hot oil as described in greater detail below. Once cooled, the hot oil is returned to the compressor 4 to be reused to further lubricate further compression operations.

The compressor package 100 may also include a control panel 22 that may provide control and feedback regarding airflow through the system, oil flow through the system, speed of the motor driving the compressors and speed of the motors 21b of the fan units 20 that cool the aftercooler 18 and the oil cooler 16 discussed below. The control panel 22 may also provide temperatures within the system.

As illustrated in FIGS. 1-6, the oil cooler 16 and the aftercooler 18 are positioned above the compressor 4 and the motor 2. Further, each of the oil cooler 16 and the aftercooler 18 are angled with respect to each other and angled with respect to a horizontal plane of the compressor package 100. In other words, the oil cooler 16 is positioned at an angle 26 between the horizontal and vertical planes of the compressor package 100. Further, aftercooler 18 is positioned at an angle 28 between the horizontal and vertical planes of the compressor package 100. In some example implementations, the angles 26, 28 may be 45°. In other applications, the angles 26, 28 may be a different angle based on an optimized angle determined based on a desired fluid flow rate through the oil cooler 16 and the aftercooler 18 and the desired temperatures to be achieved by the oil cooler 16 and the aftercooler 18.

Further, as illustrated the oil cooler 16 and the aftercooler 18 are positioned to form a V-shape with respect to each other. One or more fan units 20 may be positioned within the center of the V-shape formed by the oil cooler 16 and the aftercooler 18. Collectively, the oil cooler 16, the aftercooler 18 and the one or more fan units 20 form a cooling system 30 for the compressor package 100.

Each fan unit 20 may include a series of fan blades 21a and a motor 21b, which spins the fan blades 21a. The fan units 20 may pull air vertically down (arrow E) and push the air through the oil cooler 16 and the aftercooler 18. As illustrated both the oil cooler 16 and the aftercooler 18 are angled relative to the air flow of the air pulled vertically down (arrow E) by the fan units 20.

As explained above, in some example implementations, the oil cooler 16 includes a series of small diameter tubes through which the air (arrow E) passes to dissipate heat from the hot oil that exited the compressor. Further, in some example implementations, the tubes may also have heat fins to assist in dissipating heat from the hot oil.

Similarly, as explained above, in some example implementations, the aftercooler 18 includes a series of small diameter tubes through which the air (arrow E) passes to dissipate heat from the compressed air that has exited the compressor. In some example implementations, the tubes may also have heat fins to assist in dissipating heat from the compressed air.

After the air passes through the oil cooler 16 and the aftercooler 18, the hot air may flow at an angle A downward (arrows F) and then flow out of the compressor package 100 through slits or vents formed in a housing that surrounds the compressor package 100. As the hot air exiting the oil cooler 16 and the aftercooler 18 (arrows F) is angled away from the inlet 6 of the compressor 4, pre-heating of air entering the compressor is reduced resulting in a lower temperature air exiting the compressor 4 at the outlet 10. As the air exiting the compressor 4 has a lower temperature, less cooling is required by the aftercooler 18 allowing a smaller aftercooler 18 and a smaller fan unit 20 to be used. This can result in a smaller compressor package overall.

Further, as the air entering the compressor 4 is cooler due to the reduced pre-heating, less direct heating of the oil occurs when the air mixes with the oil in the compressor 4 resulting in lower temperature oil exiting the compressor 4 at the outlet 10. Lower temperature oil exiting the compressor 4 requires less cooling by the oil cooler 16, allowing a smaller oil cooler 16 and a smaller fan unit 20 to be used, resulting in a reduction in the size of the compressor package overall.

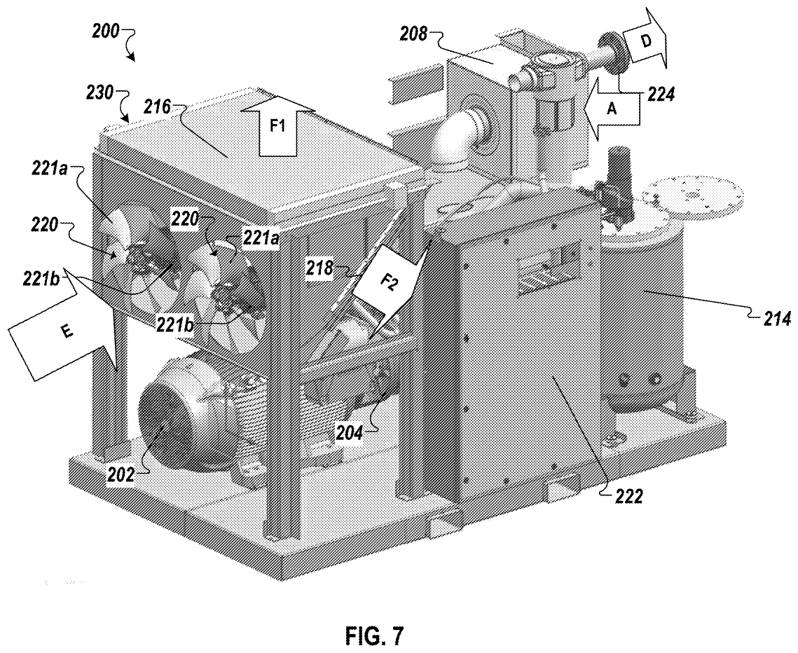

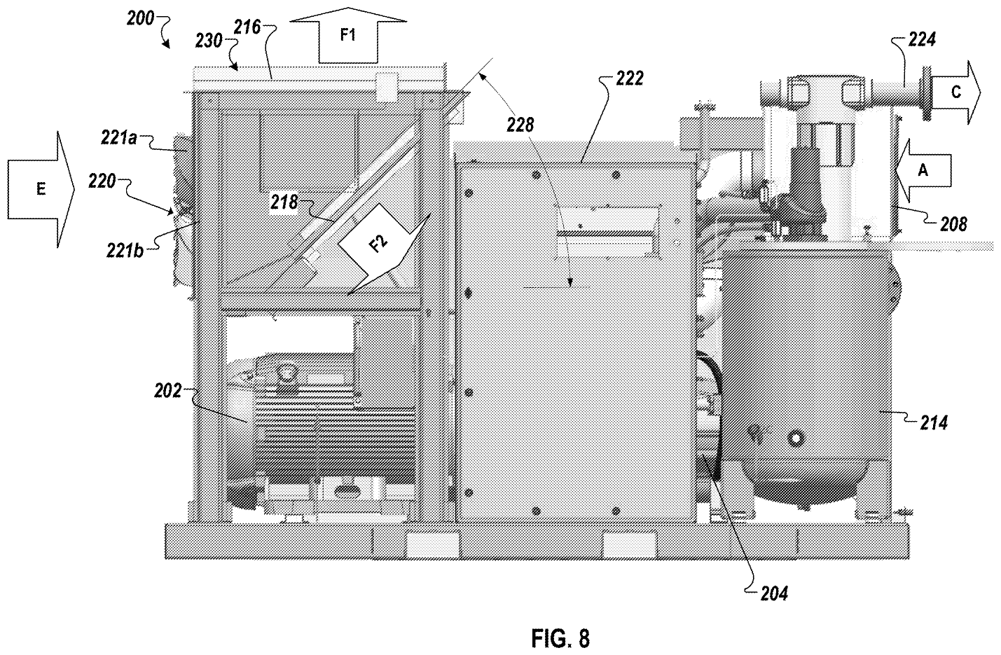

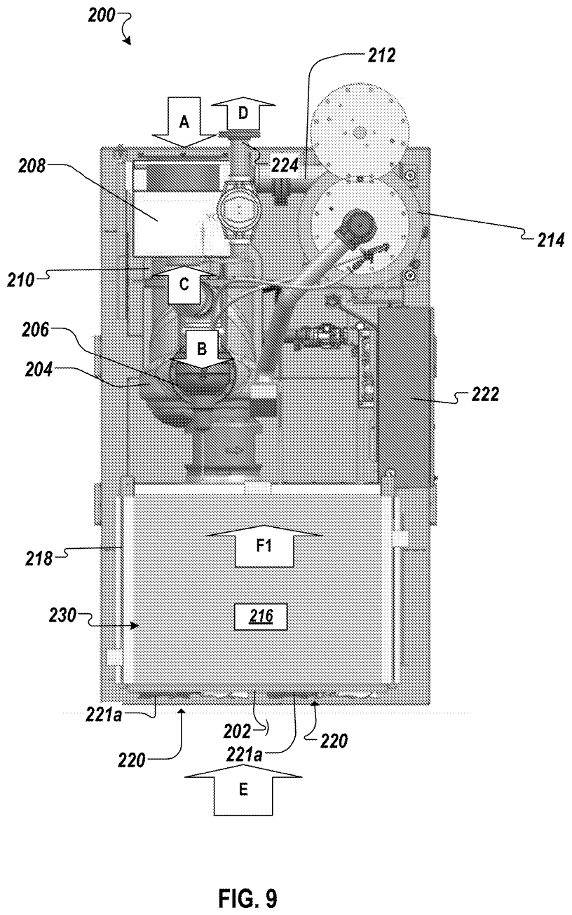

FIG. 7 illustrates a perspective view of an example air compressor package 200, in accordance with another example implementation of the present disclosure. FIG. 8 illustrates a side view of the example air compressor package 200, in accordance with the other example implementation of the present disclosure. FIG. 9 illustrates a top view of the example air compressor package 200, in accordance with the other example implementation of the present disclosure. The compressor package 200 may be used in a variety of applications requiring a supply of compressed air. For example, the compressor package may be used to supply compressed air to drive pneumatically actuated equipment or any other application requiring compressed air or other compressed gas.

The compressor package 200 of FIGS. 7-9 may have similarities to the compressor package 100 discussed above. Thus, similar reference numerals and description is provided below. The air compressor package 200 may be enclosed by a housing (removed in FIGS. 7-9) that provides openings or slits through which air may be drawn in or exhausted from the compressor package 200. The compressor package 200 may include a gas or air compressor 204 mechanically coupled to a motor 202. In some example implementations, the gas or air compressor 204 may be a twin-screw compressor or any other type of compressor that might be apparent to a person of ordinary skill in the art. Further, the motor 202 may be an electric motor, a diesel motor, a gasoline motor, or any other motor that a person of ordinary skill in the art may use to drive a compressor.

The compressor package 200 may also include a filter unit 208 through which external air is drawn (arrow A) into the compressor package 200. The filter unit 208 may be communicatively coupled to an inlet 206 of the compressor 204 by one or more tubes or pipes. The air drawn into the compressor package 200 may travel from the filter unit 208 through the inlet 206 and into the compressor 204 (arrow B).

Within the compressor 204, the air may become compressed through operation of the compressor 204 based on torque applied by the motor 202. Within the compressor 204, the air may mix with lubricating oil that keeps the rotors and compressor internal components cool. After compression, the compressed air and hot oil mixture exits the compressor 204 through a compressor outlet 210 and travels through tubes or pipes 212 communicatively coupling the compressor 204 to a separator tank 214 (arrow C). Within the separator tank 214, the compressed air is separated from the oil through swirling motion. The separator tank 214 may be communicatively coupled to the aftercooler 218 and the oil cooler 216.

The separated compressed air is provided to the aftercooler 218 via tubes or pipes (hidden in the attached figures to allow visualization of the other components). Within the aftercooler 218, the compressed air is circulated through small tubes providing increased surface area to allow cooling of the compressed air as described in greater detail below. Once cooled, the compressed air exits the compressor package through a compressor package outlet 224 (arrow D).

Once separated from the compressed air, the hot oil is provided to the oil cooler 216 via tubes or pipes (hidden in the attached figures to allow visualization of the other components). Within the oil cooler 216, the hot oil is circulated through small tubes providing increased surface area to allow cooling of the hot oil as described in greater detail below. Once cooled, the hot oil is returned to the compressor 204 to be reused to further lubricate further compression operations.

The compressor package 200 may also include a control panel 222 that may provide control and feedback regarding airflow through the system, oil flow through the system, speed of the motor driving the compressors and speed of the motors 221b of the fan units 220 that cool the aftercooler 218 and the oil cooler 216 discussed below. The control panel 222 may also provide temperatures within the system.

As illustrated in FIGS. 7-9, the oil cooler 216 and the aftercooler 218 are positioned above the compressor 204 and the motor 202. Further, the oil cooler 216 is positioned above the aftercooler 218, with the aftercooler 218 being angled with respect to the oil cooler 216. Further, the oil cooler 216 is positioned parallel to a horizontal plane of the compressor package 200 and the aftercooler 218 is angled with respect to the horizontal plane. In other words, the aftercooler 218 is positioned at an angle 228 between the horizontal and vertical planes of the compressor package 200. In some example implementations, the angle 228 may be 45°. In other applications, the angle 228 may be a different angle based on an optimized angle determined based on a desired fluid flow rate through the oil cooler 216 and the aftercooler 218 and the desired temperatures to be achieved by the oil cooler 216 and the aftercooler 218.

Further, as illustrated the oil cooler 216 and the aftercooler 218 are positioned to form an angle with respect to each other. One or more fan units 220 may be positioned within the angle formed by the oil cooler 216 and the aftercooler 218. Collectively, the oil cooler 216, the aftercooler 218 and the one or more fan units 220 form a cooling system 230 for the compressor package 200.

As illustrated, the fan units 220 are positioned and oriented to pull air through a short sidewall of the compressor package 200. Each fan unit 220 may include a series of fan blades 221a and a motor 221b, which spins the fan blades 221a. The fan units 220 may pull air horizontally through the side of the compressor package 200 (arrow E) and push the air through the oil cooler 216 and the aftercooler 218. As illustrated, the oil cooler 216 is oriented parallel to, and the aftercooler 218 is angled relative to, the air flow of the air pulled horizontally through the side of the compressor package 200 (arrow E) by the fan units 220.

Some of the air pulled into the compressor package 200 (arrow E) is pushed upward through the oil cooler 216 and exhausted out of the compressor package 200 upward (arrow F1) through slits or vents formed in a housing that surrounds the compressor package 200. Further, some of the air pulled in the compressor package 200 (arrow E) is pushed through aftercooler 218 and exhausted at a downward angle (arrow F2) into the compressor package 200.

As explained above, in some example implementations the oil cooler 216 includes a series of small diameter tubes through which the air (arrow E) passes to dissipate heat from the hot oil that exited the compressor. Further, in some example implementations the tubes may also have heat fins to assist in dissipating heat from the hot oil.

Similarly, as explained above, in some example implementations the aftercooler 218 includes a series of small diameter tubes through which the air (arrow E) passes to dissipate heat from the compressed air that has exited the compressor. In some example implementations, the tubes may also have heat fins to assist in dissipating heat from the compressed air.

As the hot air exiting the oil cooler 216 is exhausted upward out of the compressor package 200 away from the inlet 206 of the compressor 204, pre-heating of air entering the compressor is reduced resulting in a lower temperature air exiting the compressor 204 at the outlet 210. As the air exiting the compressor 204 has a lower temperature, less cooling is required by the aftercooler 218 allowing a smaller aftercooler 218 and a smaller fan unit 220 to be used. This can result in a smaller compressor package overall.

Further, as the air entering the compressor 204 is cooler due to the reduced pre-heating, less direct heating of the oil occurs when the air mixes with the oil in the compressor 204 resulting in lower temperature oil exiting the compressor 204 at the outlet 210. Lower temperature oil exiting the compressor 204 requires less cooling by the oil cooler 216 allowing a smaller oil cooler 216 and a smaller fan unit 220 to be used, resulting in a reduction in the size of the compressor package overall.

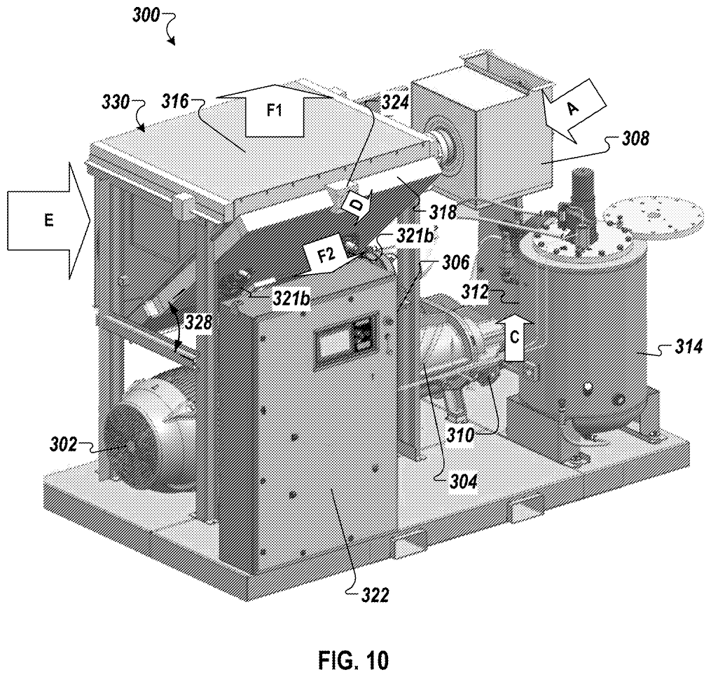

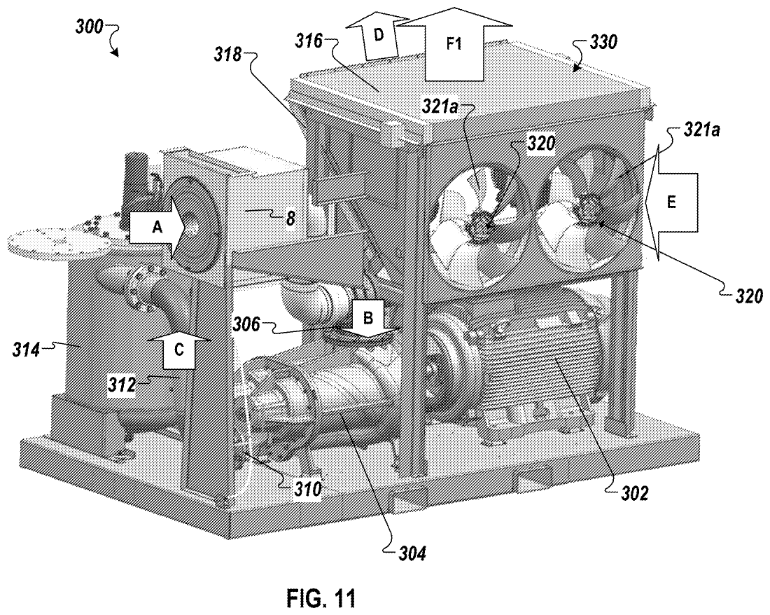

FIGS. 10 and 11 illustrate perspective views of an example air compressor package, in accordance with still another example implementation of the present disclosure. The compressor package 300 may be used in a variety of applications requiring a supply of compressed air. For example, the compressor package may be used to supply compressed air to drive pneumatically actuated equipment or any other application requiring compressed air or other compressed gas.

The compressor package 300 of FIGS. 10 & 11 may have similarities to the compressor package 100 and compressor package 200 discussed above. Thus, similar reference numerals and description is provided below. The air compressor package 300 may be enclosed by a housing (removed in FIGS. 10 & 11) that provides openings or slits through which air may be drawn in or exhausted from the compressor package 300. The compressor package 300 may include a gas or air compressor 304 mechanically coupled to a motor 302. In some example implementations, the gas or air compressor 304 may be a twin-screw compressor or any other type of compressor that might be apparent to a person of ordinary skill in the art. Further, the motor 302 may be an electric motor, a diesel motor, a gasoline motor, or any other motor that a person of ordinary skill in the art may use to drive a compressor.

The compressor package 300 may also include a filter unit 308 through which external air is drawn (arrow A) into the compressor package 300. The filter unit 308 may be communicatively coupled to an inlet 306 of the compressor 304 by one or more tubes or pipes. The air drawn into the compressor package 300 may travel from the filter unit 308 through the inlet 306 and into the compressor 304 (arrow B).

Within the compressor 304, the air may become compressed through operation of the compressor 304 based on torque applied by the motor 302. Within the compressor 304, the air may mix with lubricating oil that keeps the rotors and compressor internal components cool. After compression, the compressed air and hot oil mixture exits the compressor 304 through a compressor outlet 310 and travels through tubes or pipes 312 communicatively coupling the compressor 304 to a separator tank 314 (arrow C). Within the separator tank 314, the compressed air is separated from the oil through swirling motion. The separator tank 314 may be communicatively coupled to the aftercooler 318 and the oil cooler 316.

The separated compressed air is provided to the aftercooler 318 via tubes or pipes (hidden in the attached figures to allow visualization of the other components). Within the aftercooler 318, the compressed air is circulated through small tubes providing increased surface area to allow cooling of the compressed air as described in greater detail below. Once cooled, the compressed air exits the compressor package through a compressor package outlet 324 (arrow D).

Once separated from the compressed air, the hot oil is provided to the oil cooler 316 via tubes or pipes (hidden in the attached figures to allow visualization of the other components). Within the oil cooler 316, the hot oil is circulated through small tubes providing increased surface area to allow cooling of the hot oil as described in greater detail below. Once cooled, the hot oil is returned to the compressor 304 to be reused to further lubricate further compression operations.

The compressor package 300 may also include a control panel 322 that may provide control and feedback regarding airflow through the system, oil flow through the system, speed of the motor driving the compressors and speed of the motors 321b of the fan units 320 that cool the aftercooler 318 and the oil cooler 316 discussed below. The control panel 322 may also provide temperatures within the system.

As illustrated in FIGS. 10 & 11, the oil cooler 316 and the aftercooler 318 are positioned above the compressor 304 and the motor 302. Further, the oil cooler 316 is positioned above the aftercooler 318, with the aftercooler 318 being angled with respect to the oil cooler 316. Further the oil cooler 316 is positioned parallel to a horizontal plane of the compressor package 300 and the aftercooler 318 is angled with respect to the horizontal plane. In other words, the aftercooler 318 is positioned at an angle 328 between the horizontal and vertical planes of the compressor package 300. In some example implementations, the angle 328 may be 45°. In other applications, the angle 328 may be a different angle based on an optimized angle determined based on a desired fluid flow rate through the oil cooler 316 and the aftercooler 318 and the desired temperatures to be achieved by the oil cooler 316 and the aftercooler 318.

Further, as illustrated the oil cooler 316 and the aftercooler 318 are positioned to form an angle with respect to each other. One or more fan units 320 may be positioned within the angle formed by the oil cooler 316 and the aftercooler 318. Collectively, the oil cooler 316, the aftercooler 318 and the one or more fan units 320 form a cooling system 330 for the compressor package 300.

As illustrated, the fan units 320 are positioned and oriented to pull air through a long sidewall of the compressor package 300. Each fan unit 320 may include a series of fan blades 321a and a motor 321b, which spins the fan blades 321a. The fan units 320 may pull air horizontally through the side of the compressor package 300 (arrow E) and push the air through the oil cooler 316 and the aftercooler 318. As illustrated, the oil cooler 316 is oriented parallel to, and the aftercooler 318 is angled relative to, the air flow of the air pulled horizontally through the side of the compressor package 300 (arrow E) by the fan units 320.

Some of the air pulled into the compressor package 300 (arrow E) is pushed upward through the oil cooler 316 and exhausted out of the compressor package 300 upward (arrow F1) through slits or vents formed in a housing that surrounds the compressor package 300. Further, some of the air pulled in the compressor package 300 (arrow E) is pushed through aftercooler 318 and exhausted at a downward angle (arrow F2) into the compressor package 300.

As explained above, in some example implementations, the oil cooler 316 includes a series of small diameter tubes through which the air (arrow E) passes to dissipate heat from the hot oil that exited the compressor. Further, in some example implementations, the tubes may also have heat fins to assist in dissipating heat from the hot oil.

Similarly, as explained above, in some example implementations, the aftercooler 318 includes a series of small diameter tubes through which the air (arrow E) passes to dissipate heat from the compressed air that has exited the compressor. In some example implementations, the tubes may also have heat fins to assist in dissipating heat from the compressed air.

As the hot air exiting the oil cooler 316 is exhausted upward out of the compressor package 300 away from the inlet 306 of the compressor 304, pre-heating of air entering the compressor is reduced resulting in a lower temperature air exiting the compressor 304 at the outlet 310. As the air exiting the compressor 304 has a lower temperature, less cooling is required by the aftercooler 318 allowing a smaller aftercooler 318 and a smaller fan unit 320 to be used. This can result in a smaller compressor package overall.

Further, as the air entering the compressor 304 is cooler due to the reduced pre-heating, less direct heating of the oil occurs when the air mixes with the oil in the compressor 304 resulting in lower temperature oil exiting the compressor 304 at the outlet 310. Lower temperature oil exiting the compressor 304 requires less cooling by the oil cooler 316 allowing a smaller oil cooler 316 and a smaller fan unit 320 to be used, resulting in a reduction in the size of the compressor package overall.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The foregoing detailed description has set forth various example implementations of the devices and/or processes via the use of diagrams, schematics, and examples. Insofar as such diagrams, schematics, and examples contain one or more functions and/or operations, each function and/or operation within such diagrams, or examples can be implemented, individually and/or collectively, by a wide range of structures. While certain example implementations have been described, these implementations have been presented by way of example only and are not intended to limit the scope of the protection. Indeed, the novel methods and apparatuses described herein may be embodied in a variety of other forms. Furthermore, various omissions, substitutions and changes in the form of the devices and systems described herein may be made without departing from the spirit of the protection. The accompanying claims and their equivalents are intended to cover such forms or modifications as would fall within the scope and spirit of the protection.

What is claimed is:

1. A gas compressor package comprising:
a gas compressor;
a motor mechanically coupled to the gas compressor and applying torque to the motor to compress gas within the gas compressor;
an aftercooler communicatively coupled to the gas compressor and configured to cool compressed air that has exited the gas compressor;
an oil cooler communicatively coupled to the gas compressor and configured to cool oil that has exited the gas compressor; and
at least one fan unit pulling air from outside the gas compressor package to create an airflow within the gas compressor package and pushing the airflow through the aftercooler and the oil cooler,
wherein the aftercooler is oriented at angle to a horizontal plane of the gas compressor package and angled relative to the airflow within the gas compressor package.

2. The gas compressor package of claim 1, wherein the aftercooler and the oil cooler are located above the gas compressor and the motor.

3. The gas compressor package of claim 2, wherein the aftercooler is oriented at an angle of substantially 45° to the horizontal plane of the gas compressor package.

4. The gas compressor package of claim 2, wherein the at least one fan unit is positioned to pull air horizontally through a side of the gas compressor package, wherein the created airflow is a horizontal airflow within the gas compressor package.

5. The gas compressor package of claim 4, wherein the oil cooler is oriented parallel to the horizontal plane of the gas compressor package and parallel to airflow within the gas compressor package.

6. The gas compressor package of claim 2, wherein the at least one fan unit is positioned to pull air vertically downward through the gas compressor package, wherein the created airflow is a vertical airflow within the gas compressor package.

7. The gas compressor package of claim 6, wherein the oil cooler is oriented at an angle to the horizontal plane of the gas compressor and at an angle to the vertical airflow within the gas compressor package.

8. The gas compressor package of claim 7, wherein the oil cooler and the aftercooler form a V-shape, wherein the at least one fan unit is positioned in a center of the V-shape.

9. A cooling system for a gas compressor, the cooling system comprising:
an aftercooler configured to receive heated compressed air from the gas compressor and cool the received compressed air;
an oil cooler configured to receive heated oil from the gas compressor and configured to cool the received heated oil; and
at least one fan unit pulling air to create an airflow through the aftercooler and the oil cooler,
wherein the aftercooler is oriented at angle to a horizontal plane and angled relative to the airflow created by the at least one fan unit.

10. The cooling system of claim 9, wherein the aftercooler is oriented at an angle of substantially 45° to the horizontal plane.

11. The cooling system of claim 9, wherein the at least one fan unit is positioned to pull air horizontally, wherein the created airflow is a horizontal airflow.

12. The cooling system of claim 11, wherein the oil cooler is oriented parallel to the horizontal plane and parallel to airflow created by the at least one fan unit.

13. The cooling system of claim 9, wherein the at least one fan unit is positioned to pull air vertically downward, wherein the created airflow is a vertical airflow.

14. The cooling system of claim 13, wherein the oil cooler is oriented at an angle to the horizontal plane and at an angle to the vertical airflow created by the at least one fan unit.

15. The cooling system of claim 14, wherein the oil cooler and the aftercooler form a V-shape, wherein the at least one fan unit is positioned in a center of the V-shape.
